(19) United States
(12) Patent Application Publication
(10) Pub. No.: US 2003/0196536 A1
(43) Pub. Date: Oct. 23, 2003

(54) Grit-coated glass-cutting saw blade

(75) Inventor: Heinz Herrmann, Tonisvorst (DE)

Correspondence Address: THE FIRM OF KARL F ROSS, 5676 RIVERDALE AVENUE, PO BOX 900, RIVERDALE (BRONX), NY, 10471-0900, US

(73) Assignee: BOHLE AG

(21) Appl. No.: 10/412,768

(22) Filed: Apr. 11, 2003

(30) Foreign Application Priority Data
Apr. 19, 2002 (DE) 20206159.0

(51) Int. Cl. B26D 1/46

(52) U.S. Cl. 83/835; 83/820

(57) ABSTRACT

A glass-cutting saw blade has an elongated body adapted to move transversely to a cutting direction and having a short leading edge extending transversely to the direction, a pair of long sides extending generally parallel to the direction back from ends of the leading edge, and a short trailing edge extending transversely to the direction and bridging rear ends of the sides. A grit coating is provided both on the leading edge and on the trailing edge. The grit coatings extend partially from the respective edges onto adjacent portions of the sides. In addition the body is of rectangular section. Such a blade can be a standard jig- or reciprocating-saw blade, or can be continuous and formed as a band-saw blade.

### FIELD OF THE INVENTION

The present invention relates to a saw blade. More particularly this invention concerns such a blade used for cutting glass along a nonstraight line.

### BACKGROUND OF THE INVENTION

In shops producing custom mirrors, glass artwork, Tiffany-style glass items, and the like it is necessary to be able to cut glass along curves. For instance the production of a stained-glass lamp or window requires that virtually every piece be custom cut and, if necessary, trimmed to produce the elements that will make up the desired picture or design.

Such cutting is normally done by a blade that is elongated and is either moved continuously in its longitudinal direction, as in a band saw, or reciprocated in this direction, as in a jig saw. The blade itself is of elongated section, having a short leading edge, a pair of longer sides extending backward in a cutting direction from ends of the leading edge, and a trailing edge that bridges rear ends of the sides. Rather than teeth, such a blade is provided on its leading edge with a grit coating, typically of carbide or diamond particles that can cut glass.

While such a blade is highly effective when making a straight cut, its service life when cutting curves is often reduced, and, the sharper the curves it has to cut, the shorter its service life. This is due to the fact that the trailing portions of the sides of the blade engage the hard sides of the cut and are abraded thereby. In a relatively short time the trailing edge is worn away and eventually the cross section of the blade is reduced to the point that the blade breaks.

### OBJECTS OF THE INVENTION

It is therefore an object of the present invention to provide an improved grit-coated glass-cutting blade.

Another object is the provision of such an improved grit-coated glass-cutting blade which overcomes the above-given disadvantages, that is which will have a long service life even if used to cut curves and the like.

### SUMMARY OF THE INVENTION

A glass-cutting saw blade has an elongated body adapted to move transversely to a cutting direction and having a short leading edge or face extending transversely to the direction, a pair of long sides extending generally parallel to the direction back from ends of the leading edge, and a short trailing edge or face extending transversely to the direction and bridging rear ends of the sides. In accordance with the invention a grit coating is provided both on the leading edge and on the trailing edge. The coating on the trailing edge can be continuous or only in spaced zones.

Thus with this system the trailing edge will not be subject to wear, but instead will serve to smooth or widen the kerf made by the leading edge. The glass workpiece will not be able to directly contact the steel blade body so that it will not be worn away. Furthermore the blade according to the invention can be used bidirectionally, that is it can cut in and against the normal cutting direction with no difficulty. When the leading-edge grit layer starts to wear off, the blade can also be reversed and used, giving it twice the service life of a standard blade. What is more, the grit-covered trailing edge will prevent the blade from jamming in the kerf; instead it will smooth the kerf behind the cut line, especially when cutting a curve with a small radius.

In accordance with the invention the grit coatings extend partially from the respective edges onto adjacent portions of the sides. In addition the body is of rectangular section so that the leading and trailing edges and the two sides are all planar. Such a blade can be a standard jig- or reciprocating-saw blade, or can be continuous and formed as a band-saw blade. It is also possible for the sides and edges to be curved, giving the blade an oval section.

In another embodiment of the saw blade according to the invention the blade has longitudinally spaced regions devoid of any coating. These regions devoid of coating alternate with coated regions.

### BRIEF DESCRIPTION OF THE DRAWING

The above and other objects, features, and advantages will become more readily apparent from the following description, reference being made to the accompanying drawing in which:

FIG. 1 is a large-scale cross section through a blade according to the invention;

FIG. 2 is a similar section through another blade;

FIG. 3 is a top view illustrating use of the blade in accordance with the invention; and

FIGS. 4 and 5 are side and sectional end views of a band saw incorporating the blade of this invention.

### SPECIFIC DESCRIPTION

As seen in FIG. 1 a saw blade 1 according to the invention is elongated in a direction perpendicular to the plane of view and is intended to advance through a workpiece in a cutting direction 2. This blade 1 is of rectangular section and has a short leading edge 3, an identical short trailing edge 4 parallel to the edge 3, and a pair of longer parallel sides 7 and 8 extending between ends of the edges 3 and 4.

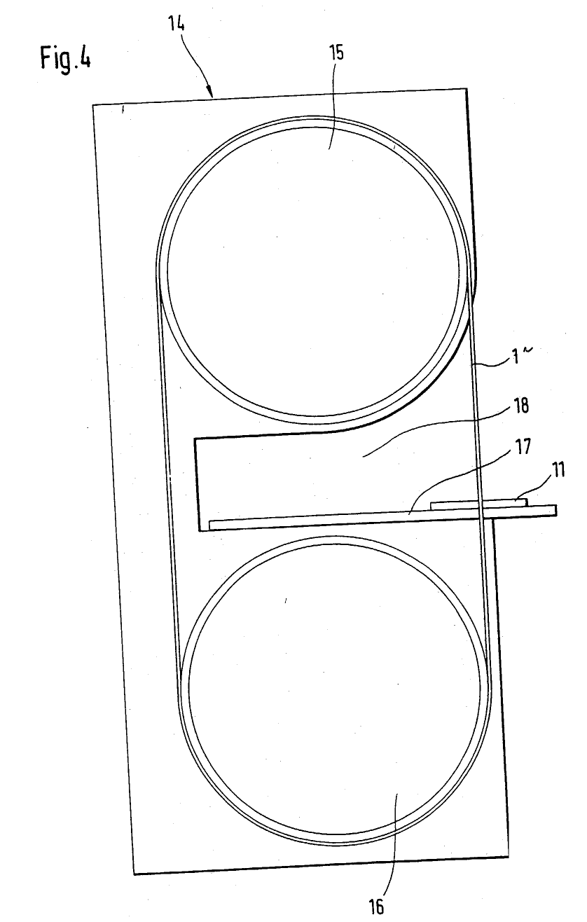

The leading edge 3 and short leading portions of the side edges 7 and 8 are covered by a coating 5 incorporating diamond grit. In addition according to the invention the trailing edge 4 and short trailing portions of the side edges 7 and 8 are also covered by another such grit coating 6. Thus as shown in FIG. 3 when the blade 1 is moved in the direction 2 through a workpiece along a curved cut line 13, it forms a kerf 12. The trailing edge 4 covered with the coating 6 that is not visible in FIG. 3 engages sides of the kerf 12 but, since it has this coating 6, it is not worn by contact with the glass of the workpiece 11. Instead it actually smooths the sides of the kerf 12.

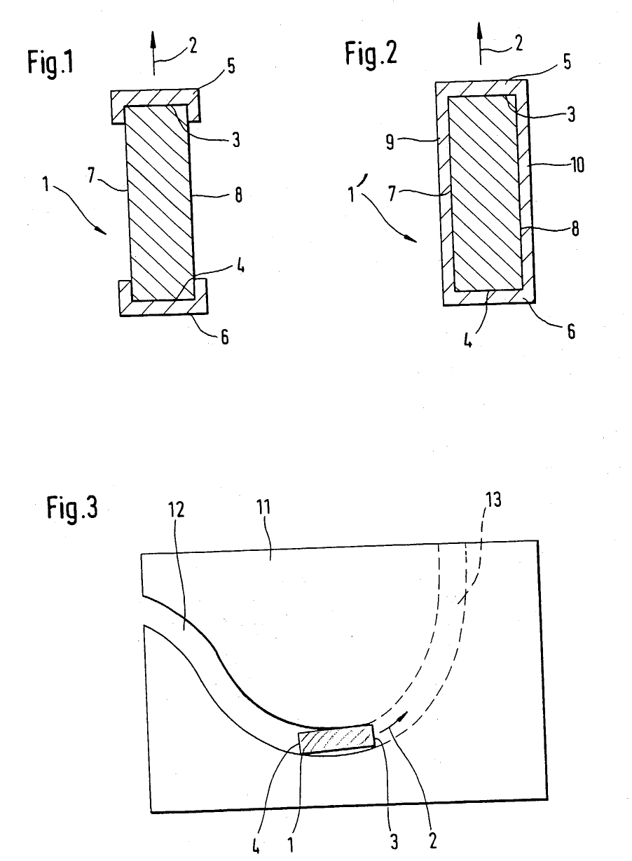

FIG. 2 shows another blade 1′ which is identical to the blade 1 of FIG. 1 except that the side surfaces 7 and 8 have grit coatings 9 and 10 so that actually the entire blade is coated with grit, with all of its surfaces protected.

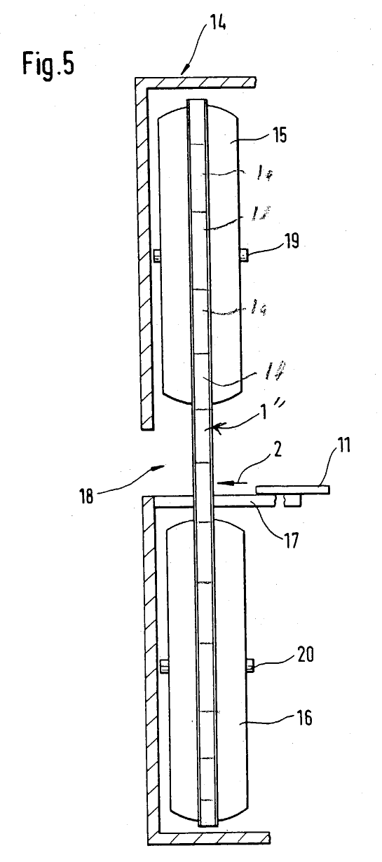

FIGS. 4 and 5 show a band saw 14 having a pair of wheels 15 and 16 over which the blade 1, here formed as a continuous belt, is spanned. A table 17 in a mouth 18 of the saw supports the workpiece 11 which is moved in the direction 2 parallel to the rotation axles 19 and 20 of the wheels 15 and 16.

FIGS. 4 and 5 show a blade 1″ which is substantially identical to that of FIG. 2 except that it has regions 1a that carry the coatings 5, 6, 9, and 10, and regions 1b devoid of any such coating.

I claim:

1. A glass-cutting saw blade comprising:
an elongated body adapted to move transversely to a cutting direction and having a short leading edge extending transversely to the direction, a pair of long sides extending generally parallel to the direction back from ends of the leading edge, and a short trailing edge extending transversely to the direction and bridging rear ends of the sides;
a grit coating on the leading edge; and
another grit coating on the trailing edge.

2. The saw blade defined in claim 1 wherein the grit coatings extend partially from the respective edges onto adjacent portions of the sides.

3. The saw blade defined in claim 1 wherein the grit coatings extend from the respective edges over the sides and completely cover same.

4. The saw blade defined in claim 1 wherein the body is of rectangular section.

5. The saw blade defined in claim 1 wherein the body is continuous and is formed as a band-saw blade.

6. The saw blade defined in claim 1 wherein the blade has longitudinally spaced regions devoid of any coating.

7. The saw blade defined in claim 6 wherein the regions devoid of coating alternate with coated regions.
